(19) United States
(12) Patent Application Publication
(10) Pub. No.: US 2026/0003317 A1
(43) Pub. Date: Jan. 1, 2026

(54) PAPER TRANSPORT DEVICE

(71) Applicant: FUJIFILM Business Innovation Corp., Tokyo (JP)

(72) Inventor: Yoshinori KOIKE, Kanagawa (JP)

(73) Assignee: FUJIFILM Business Innovation Corp., Tokyo (JP)

(21) Appl. No.: 18/956,097

(22) Filed: Nov. 22, 2024

(30) Foreign Application Priority Data
Jun. 28, 2024 (JP) 2024-104794

(51) Int. Cl. G03G 21/16

(52) U.S. Cl. CPC G03G 21/1638; G03G 21/1619; G03G 21/1647

(57) ABSTRACT

A paper transport device includes: a paper transport path on which paper is transported; and a side cover that is rotatable about a support shaft with respect to a side surface of a device main body and is capable of being disposed at a closed position and an open position, in which the side cover is configured to form at least a part of the paper transport path between the side cover and the device main body at the closed position and to expose at least a part of the paper transport path at the open position, the side cover includes an exterior cover and an internal structure disposed on a device main body side of the exterior cover, the internal structure of the side cover includes a pair of frames disposed at an interval in a lateral direction in which the support shaft of the side cover extends, each of the pair of frames extends in a longitudinal direction intersecting the lateral direction, is fastened to the exterior cover, and includes a proximal end close to the support shaft of the side cover and a distal end far from the support shaft, the internal structure of the side cover includes a connecting member that connects the distal ends of the pair of frames to each other and extends in the lateral direction, and the connecting member includes an extending portion that extends outward in the longitudinal direction with respect to the distal end of each of the pair of frames.

### CROSS-REFERENCE TO RELATED APPLICATIONS

This application is based on and claims priority under 35 USC 119 from Japanese Patent Application No. 2024-104794 filed Jun. 28, 2024.

### BACKGROUND

### (i) Technical Field

The present invention relates to a paper transport device.

### (ii) Related Art

A paper transport device includes a side cover. The side cover is rotatable about a support shaft with respect to a side surface of a device main body, and can be disposed at a closed position and an open position. The side cover forms at least a part of a paper transport path between the side cover and the device main body at the closed position, and exposes at least a part of the paper transport path at the open position.

For example, in a case where paper is jammed in the paper transport path, a user moves the side cover to the open position and performs jam processing of removing the paper.

JP1997-246742A discloses an office machine in which disassembly is facilitated by reducing the number of screws for fixing an exterior member.

JP2003-311739A discloses a configuration related to recycling of a paper feed cassette of a printer, in which an indication that coupled components are made of the same material is displayed on the paper feed cassette so that an operator can determine that the coupled components do not need to be disassembled.

JP2003-341176A discloses a holding structure of a component that is to be removed from a recycling component to be reused during reuse in an image forming apparatus.

### SUMMARY

The side cover of the paper transport device includes an exterior cover and an internal structure disposed on a device main body side of the exterior cover. The exterior cover may become yellowed or scratched. In this case, it is conceivable to separate the exterior cover and the internal structure from each other and to replace the exterior cover.

Here, the internal structure includes a pair of frames disposed at an interval in a lateral direction in which the support shaft of the side cover extends with respect to the device main body. Each of the pair of frames extends in a longitudinal direction intersecting the lateral direction, is fastened to the exterior cover, and includes a proximal end close to the support shaft of the side cover and a distal end far from the support shaft.

In a case where the internal structure is separated from the exterior cover in an operation of replacing the exterior cover, the distal end of each of the pair of frames of the internal structure may be in a state of protruding away from the exterior cover. In this case, adverse effects such as damage to the distal end or impairment of safety of the operator are conceivable. Therefore, there is a demand for a structure in which the distal end of each of the pair of frames in the internal structure of the side cover is protected.

Aspects of non-limiting embodiments of the present disclosure relate to a paper transport device in which a distal end of each of a pair of frames in an internal structure of a side cover is protected.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided a paper transport device including: a paper transport path on which paper is transported; and a side cover that is rotatable about a support shaft with respect to a side surface of a device main body and is capable of being disposed at a closed position and an open position, in which the side cover is configured to form at least a part of the paper transport path between the side cover and the device main body at the closed position and to expose at least a part of the paper transport path at the open position, the side cover includes an exterior cover and an internal structure disposed on a device main body side of the exterior cover, the internal structure of the side cover includes a pair of frames disposed at an interval in a lateral direction in which the support shaft of the side cover extends, each of the pair of frames extends in a longitudinal direction intersecting the lateral direction, is fastened to the exterior cover, and includes a proximal end close to the support shaft of the side cover and a distal end far from the support shaft, the internal structure of the side cover includes a connecting member that connects the distal ends of the pair of frames to each other and extends in the lateral direction, and the connecting member includes an extending portion that extends outward in the longitudinal direction with respect to the distal end of each of the pair of frames.

### BRIEF DESCRIPTION OF THE DRAWINGS

Exemplary embodiment(s) of the present invention will be described in detail based on the following figures, wherein:

FIG. 1 is a schematic view showing an image forming apparatus;

FIG. 2 is a front perspective view of a side cover;

FIG. 3 is a front perspective view of an internal structure;

FIG. 4 is a perspective view showing a frame coupling structure on a left side of a connecting member;

FIG. 5 is a perspective view showing a frame coupling structure on a right side of the connecting member;

FIG. 6 is a cross-sectional view taken along line A1-A1 in FIG. 4;

FIG. 7 is a cross-sectional view taken along line A2-A2 in FIG. 5;

FIG. 8 is a front perspective view of an exterior cover;

FIG. 9 is a perspective view showing a compression coil spring on a left side of a handle body;

FIG. 10 is a perspective view showing a compression coil spring on a right side of the handle body;

FIG. 11 is a rear perspective view of the handle body;

FIG. 12 is a front perspective view of the cover body;

FIG. 13 is a cross-sectional view taken along line B-B in FIG. 12; and

FIG. 14 is a side view showing the internal structure placed on a jig.

### DETAILED DESCRIPTION

Hereinafter, an exemplary embodiment according to the present invention will be described with reference to the accompanying drawings. Configurations described below are examples for description and can be changed as appropriate. Identical or similar elements are designated by identical reference numerals in all drawings, and duplicate description is omitted.

A paper transport device is a device having a paper transport path on which paper is transported from one place to another place. An apparatus to which the paper transport device is applied is not limited. Hereinafter, a paper transport device included in an image forming apparatus will be described.

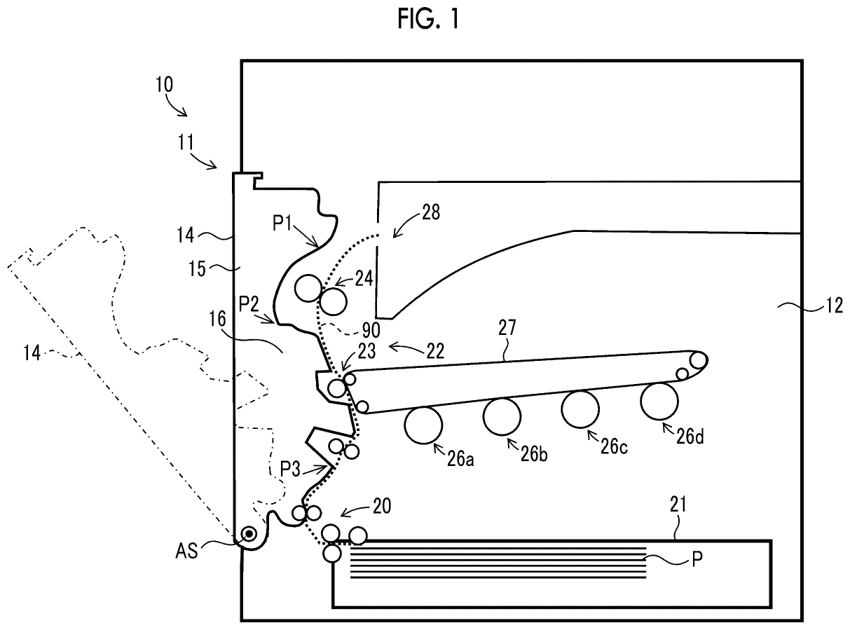

FIG. 1 is a schematic view showing an image forming apparatus 10. The image forming apparatus 10 is an electrophotographic printing apparatus. The image forming apparatus 10 includes a paper feed section 20, an image forming section 22, a paper discharge section 28, and a paper transport path 90. The paper transport path 90 extends between the paper feed section 20 and the paper discharge section 28.

The paper feed section 20 is disposed upstream of the image forming section 22 and feeds paper P in a paper feed cassette 21 toward the image forming section 22. The image forming section 22 forms an image on the paper P. The paper discharge section 28 is disposed downstream of the image forming section 22 and discharges the paper P on which the image is formed by the image forming section 22.

The image forming section 22 includes one or more photosensitive units 26a to 26d, an intermediate transfer belt 27, a secondary transfer unit 23, and a fixing unit 24. The photosensitive units 26a to 26d each form a toner image on the rotating intermediate transfer belt 27. The toner image on the intermediate transfer belt 27 is transferred to the paper P by the secondary transfer unit 23. The toner image on the paper P is fixed on the paper P by the fixing unit 24. In addition, the image forming apparatus 10 may employ an electrophotographic printing technology in the related art.

The image forming apparatus 10 includes a paper transport device 11. The paper transport device 11 includes a device main body 12, a side cover 14, and the paper transport path 90. The side cover 14 is rotatable about a support shaft AS relative to a side surface of the device main body 12 and can be disposed at a closed position (see a solid line in FIG. 1) and an open position (see a one-dot chain line in FIG. 1). The side cover 14 includes a chute that guides the paper P. The side cover 14 forms a part of the paper transport path 90 between the side cover 14 and the device main body 12 at the closed position, and exposes a part of the paper transport path 90 at the open position. For example, in a case where the paper P is jammed in the paper transport path 90, a user moves the side cover 14 to the open position and performs jam processing of removing the paper P.

The paper transport path 90 includes a reversing transport path for two-sided printing. The reversing transport path is provided through positions indicated by reference numerals P1, P2, and P3 in FIG. 1, and the reversing transport path between reference numerals P2 and P3 is provided inside the side cover 14. In a case of two-sided printing, the paper P on which the image is formed on a front surface returns to a side downstream of the paper transport path 90 while passing through the positions of reference numerals P1, P2, and P3 in order. Then, the paper P advances to the secondary transfer unit 23 and the fixing unit 24 again, where an image is formed on a rear surface of the paper P, and the paper P is discharged. The paper transport path 90 may employ a technology of the reversing transport path provided in the side cover 14 in the related art.

The side cover 14 includes an exterior cover 15 and an internal structure 16 disposed on a device main body 12 side of the exterior cover 15. The exterior cover 15 may become yellowed or scratched. In this case, the exterior cover 15 and the internal structure 16 are separated from each other, and the exterior cover 15 is replaced. This replacement operation is performed by detaching the side cover 14 from the device main body 12 shown in FIG. 1.

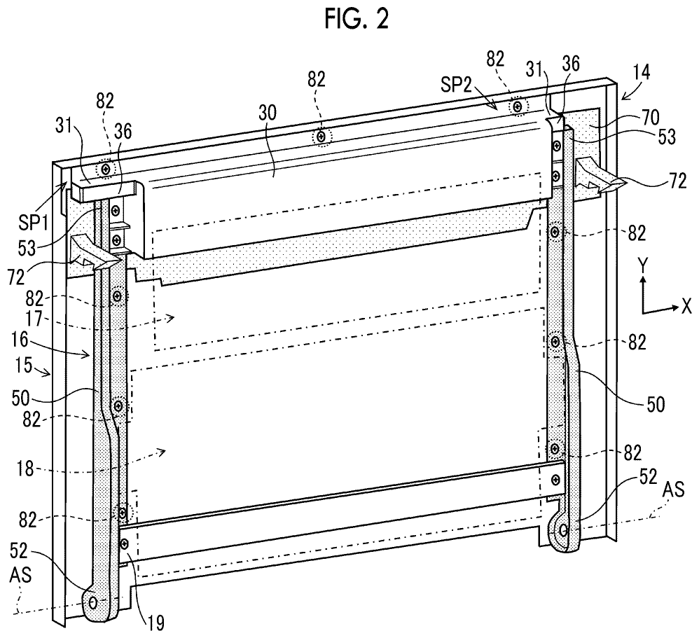

FIG. 2 is a front perspective view of the side cover 14. In each figure described below, a front surface is a surface of the side cover 14 facing the device main body 12, and a rear surface is a surface of the side cover 14 facing outward. In addition, an x direction is a lateral direction and is a direction in which the support shaft AS of the side cover 14 extends. A y direction is a longitudinal direction intersecting the x direction, and particularly, in this exemplary embodiment, the y direction is a direction perpendicular to the x direction. In addition, in each figure, an arrow in the x direction indicates a right side of the side cover 14, and an arrow in the y direction indicates an upper side of the side cover 14.

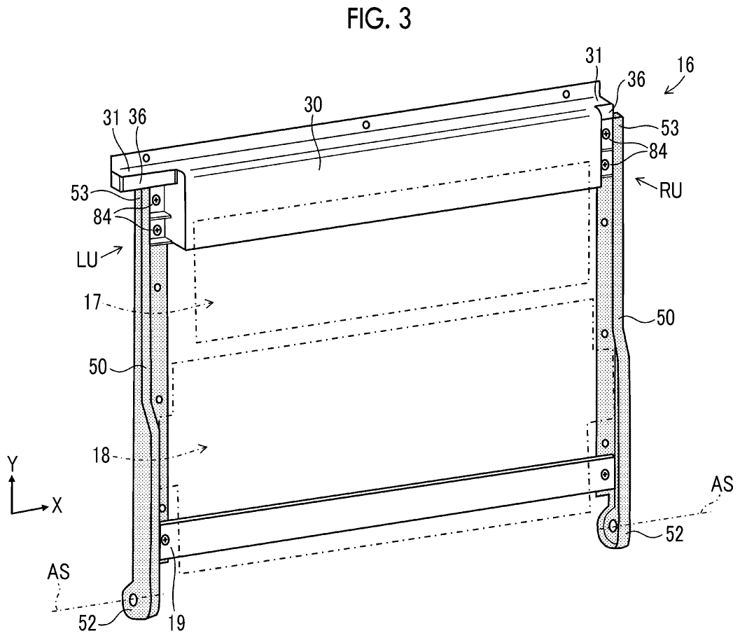

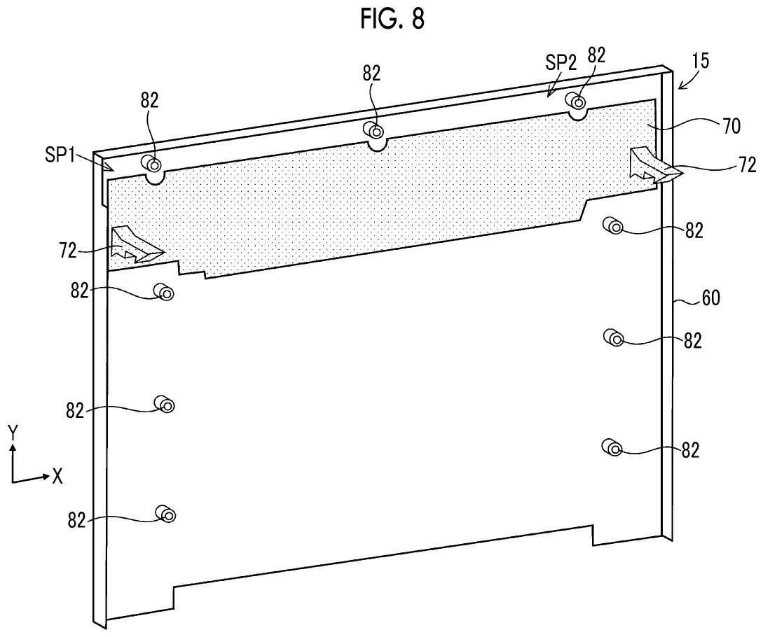

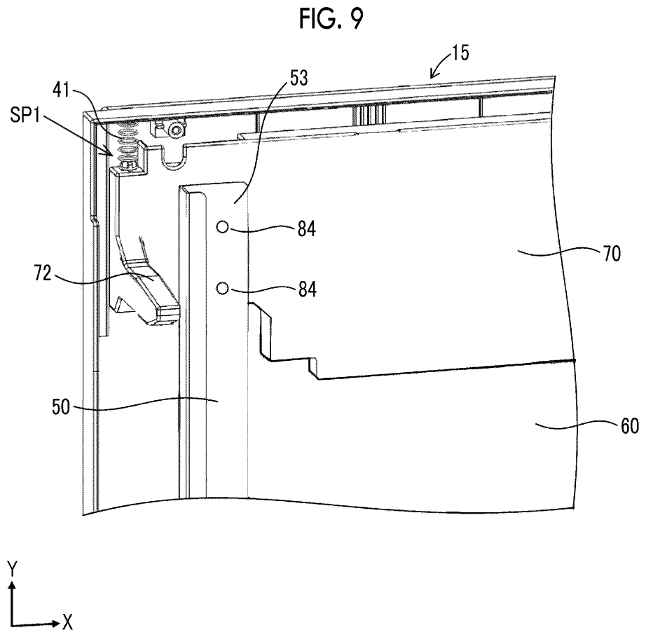

In FIGS. 2 and 3, a first unit 17 and a second unit 18 of the internal structure 16 are schematically shown by a one-dot chain line, and detailed shapes thereof are omitted. Each of the first unit 17 and the second unit 18 actually includes a chute that guides the paper P and is a portion that protrudes relatively largely toward the device main body 12. In addition, in FIGS. 2 and 8, a shape of a handle body 70, which will be described later, is simplified, and a more detailed shape of the handle body 70 is shown in FIGS. 9 to 11.

As shown in FIG. 2, the side cover 14 includes the exterior cover 15 and the internal structure 16. The internal structure 16 is attached to the exterior cover 15. FIG. 3 is a front perspective view of the internal structure 16 detached from the exterior cover 15. FIG. 8 is a front perspective view of the exterior cover 15.

As shown in FIG. 2, the internal structure 16 is attached to the exterior cover 15 by a plurality of fastening portions 82. Each of all the fastening portions 82 has a tool receiving portion facing a front surface side such that fastening can be released by an operation with a tool from the front surface side.

Specifically, the fastening portion 82 consists of a male screw and a female screw (a female screw provided in the exterior cover 15) into which the male screw is screwed. All the male screws have a recess (the tool receiving portion) in a head facing the front surface side. Therefore, for each of all the male screws, an operator can access the recess in the head of the male screw from the front surface side with a tool such as a screwdriver, to release the screwing of the male screw. That is, the internal structure 16 can be detached from the exterior cover 15 only by the access with the tool from the front surface side. The operator can remove the internal structure 16 from the exterior cover 15, thereby allowing the exterior cover 15 to be treated as a single unit for replacement.

As shown in FIG. 3, the internal structure 16 includes a pair of frames 50 disposed at an interval in the lateral direction. Each of the pair of frames 50 extends in the longitudinal direction, is fastened to the exterior cover 15 (see FIG. 8), and includes a proximal end 52 close to the support shaft AS of the side cover 14 and a distal end 53 far from the support shaft AS.

The internal structure 16 includes the first unit 17, the second unit 18, and a coupling plate 19. The first unit 17, the second unit 18, and the coupling plate 19 are located between the frame 50 on a left side and the frame 50 on the right side and are fastened to each of the two frames 50. The first unit 17 includes a connecting member 30. As shown in FIG. 3, the first unit 17 is located at upper portions of the two frames 50. The second unit 18 is located below the first unit 17.

The coupling plate 19 is located at lower portions of the two frames 50. The coupling plate 19 is located on a back side of the second unit 18 in a case where the internal structure 16 is viewed from the front surface.

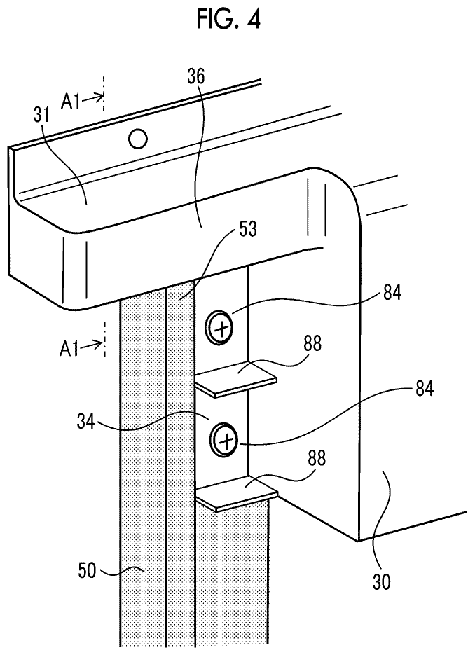

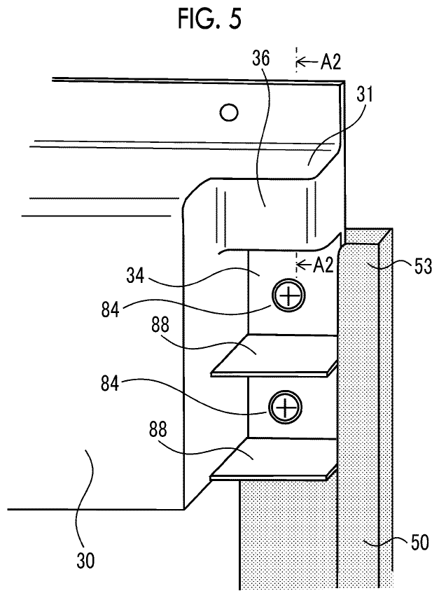

The first unit 17 includes the connecting member 30 that connects the distal ends 53 of the pair of frames 50 to each other and extends in the lateral direction. FIG. 4 is an enlarged view showing a portion indicated by an arrow LU in FIG. 3, and shows a frame coupling structure on a left side of the connecting member 30. In addition, FIG. 5 is an enlarged view showing a portion indicated by an arrow RU in FIG. 3, and shows a frame coupling structure on a right side of the connecting member 30.

As shown in FIGS. 4 and 5, the connecting member 30 includes an extending portion 31 that extends outward in the longitudinal direction with respect to the distal end 53 of each of the pair of frames 50. In a case where the internal structure 16 is separated from the exterior cover 15, each of the distal ends 53 of the pair of frames 50 is protected by the extending portion 31 of the connecting member 30.

As shown in FIG. 4, an extending portion 31 on the left side of the connecting member 30 extends outward in the lateral direction with respect to the distal end 53 of the frame 50. Accordingly, in a case where the internal structure 16 is separated from the exterior cover 15, contact of an object with the distal end 53 of the left frame 50 from outside in the lateral direction is restricted.

As shown in FIGS. 4 and 5, the connecting member 30 includes an overlapping portion 34 that overlaps with the distal end 53 of the frame 50 for each of the pair of frames 50. The overlapping portion 34 of the connecting member 30 is attached to the distal end 53 of the frame 50 by two fastening portions 84 with two screws. On the other hand, as shown in FIG. 2, the extending portion 31 (an upper end portion of the connecting member 30 in this exemplary embodiment) of the connecting member 30 is attached to the exterior cover 15 by three fastening portions 82 with three screws. With this configuration, the fastening portion 84 between the connecting member 30 and the frame 50 and the fastening portion 82 between the connecting member 30 and the exterior cover 15 may be individually released.

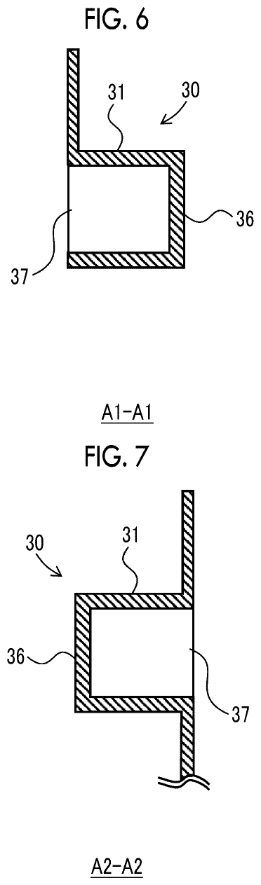

As shown in FIGS. 4 and 5, the extending portion 31 of the connecting member 30 includes a protruding portion 36. FIG. 6 is a cross-sectional view taken along line A1-A1 of FIG. 4, and FIG. 7 is a cross-sectional view taken along line A2-A2 of FIG. 5. The protruding portion 36 has a hat shape in which a cross section along the longitudinal direction has an opening 37 on an exterior cover 15 side as shown in FIGS. 6 and 7, and extends in the lateral direction as shown in FIGS. 4 and 5. The protruding portion 36 protrudes toward the front surface side with respect to the fastening portion 82 (see FIG. 2). As a result, torsional rigidity of the connecting member 30 is increased.

In addition, a part of the connecting member 30 may form at least a part of the paper transport path between the part of the connecting member 30 and the device main body 12 at the closed position of the side cover 14 with respect to the device main body 12. Accordingly, the paper may be transported by using the connecting member 30.

As shown in FIG. 8, the exterior cover 15 includes a cover body 60 and the handle body 70. The handle body 70 is disposed to be slidable in the longitudinal direction with respect to the cover body 60. The handle body 70 has two hook portions 72. Each of the two hook portions 72 protrudes toward an inside (device main body side) of the exterior cover 15 and is engaged with an engaging portion (not shown) of the device main body 12.

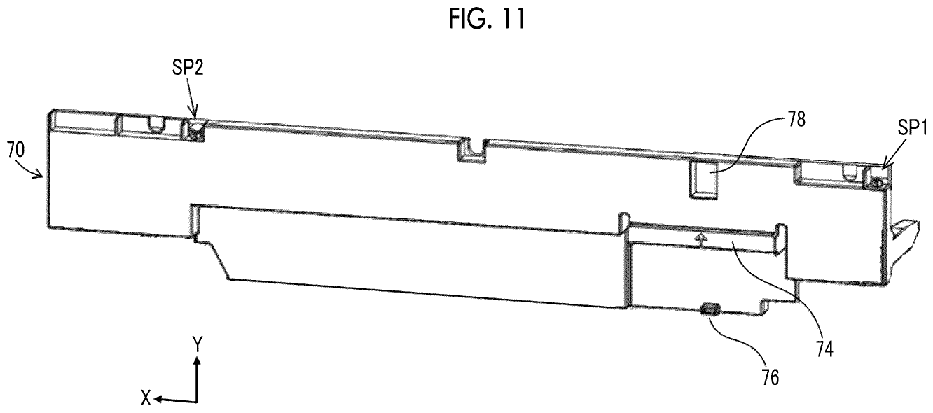

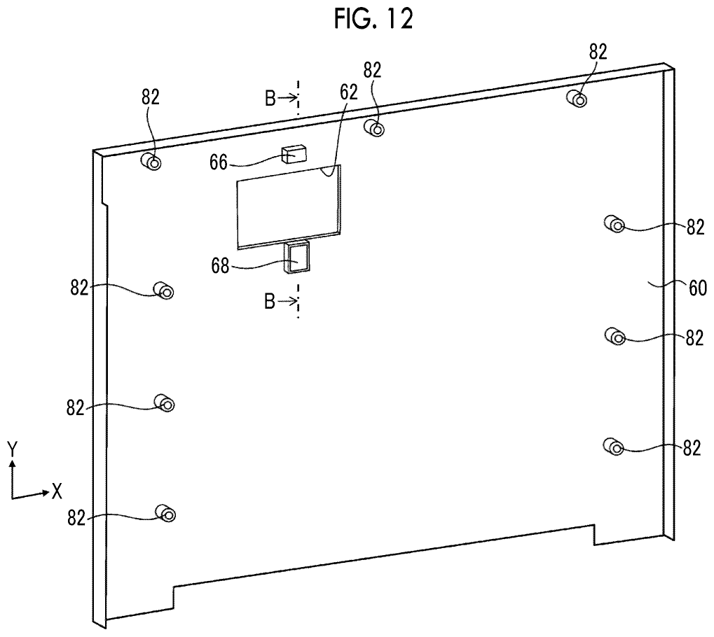

FIG. 11 is a rear perspective view of the handle body 70. FIG. 12 is a front perspective view showing the cover body 60 (the exterior cover 15 from which the handle body 70 is removed).

As shown in FIG. 12, the cover body 60 has an opening 62. In addition, as shown in FIG. 11, the handle body 70 includes a handle portion 74 that is operated by the user. The handle portion 74 is exposed to an outside of the side cover 14 from the opening 62 of the cover body 60.

The user slides the handle portion 74 upward (in a direction in which the hook portion 72 of the handle body 70 and the engaging portion of the device main body 12 are disengaged from each other) from the outside of the side cover 14. That is, the entire handle body 70 is slid. Accordingly, the hook portion 72 and the engaging portion can be disengaged from each other. The user can operate the handle portion 74 to disengage the hook portion 72 from the engaging portion and move the side cover 14 from the closed position (see the solid line in FIG. 1) to the open position (see the one-dot chain line in FIG. 1).

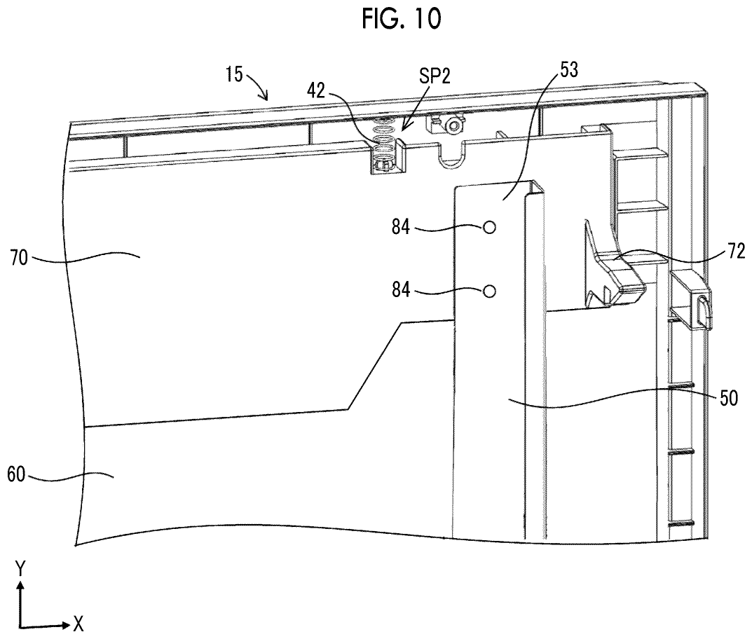

As shown in FIGS. 9 and 10, the exterior cover 15 includes two compression coil springs 41 and 42. As shown in FIG. 9, the compression coil spring 41 on the left side is disposed between an upper left end portion of the handle body 70 and an inner surface of an edge portion of the cover body 60. In addition, as shown in FIG. 10, the compression coil spring 42 on the right side is disposed between an upper right portion of the handle body 70 and the inner surface of the edge portion of the cover body 60.

In each figure, a position of the compression coil spring 41 is indicated by reference numeral SP1, and a position of the compression coil spring 42 is indicated by reference numeral SP2.

In a case where the user pulls up the handle portion 74 (see FIG. 11), the handle body 70 slides in the longitudinal direction against biasing forces of the two compression coil springs 41 and 42, and in a case where the user releases the handle portion 74, the handle body 70 returns to an original position thereof by the biasing forces of the two compression coil springs 41 and 42. As shown in FIGS. 9 and 10, the handle body 70 is located between the cover body 60 and the two frames 50 and slides therebetween.

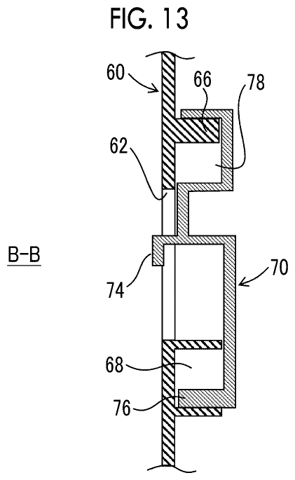

As shown in FIG. 11, the handle body 70 has a boss 76 and a recess portion 78. In addition, as shown in FIG. 12, the cover body 60 includes a boss 66 and a recess portion 68. FIG. 13 is a view showing a cross section taken along line B-B of FIG. 12, and shows a cross section of the side cover 14 in a state where the handle body 70 is assembled to the cover body 60. As shown in FIG. 13, the boss 76 of the handle body 70 fits into the recess portion 68 of the cover body 60 to guide sliding of the handle body 70. In addition, the boss 66 of the cover body 60 fits into the recess portion 78 of the handle body 70 to guide the sliding of the handle body 70. With this configuration, rattling during the sliding of the handle body 70 is suppressed.

As described with reference to FIG. 2, the side cover 14 has the plurality of fastening portions 82 that fasten the exterior cover 15 and the internal structure 16, and all the fastening portions 82 can be fastened and released by the operation with the tool from the front surface side. Therefore, the operator can easily separate the exterior cover 15 and the internal structure 16 from each other, and can reduce the number of processes for replacing the exterior cover 15.

In addition, after the internal structure 16 is detached from the exterior cover 15, the internal structure 16 can have a self-supporting rigidity as shown in FIG. 3. The lower portions of the two frames 50 are connected by the coupling plate 19, and the upper portions of the two frames 50 are connected by the connecting member 30. An upper portion of the connecting member 30 has a box shape and extends in the lateral direction, and the extending portion 31 of the connecting member 30 has the protruding portion 36. In addition, the overlapping portion 34 (see FIGS. 4 and 5) of the connecting member 30 has a rib 88, which enhances surface rigidity. As described above, the connecting member 30 has such a shape that the rigidity against bending/twisting and rigidity at screw fastening points are secured. Accordingly, the internal structure 16 has high rigidity even in a case of being treated as a single unit separated from the exterior cover 15 and can be handled as a single unit.

In addition, the handle body 70 is configured to be placed on the exterior cover 15 independently of the internal structure 16. For example, since there is no need to cut out the connecting member 30 to secure a region of the handle body 70, the rigidity of the internal structure 16 can be increased.

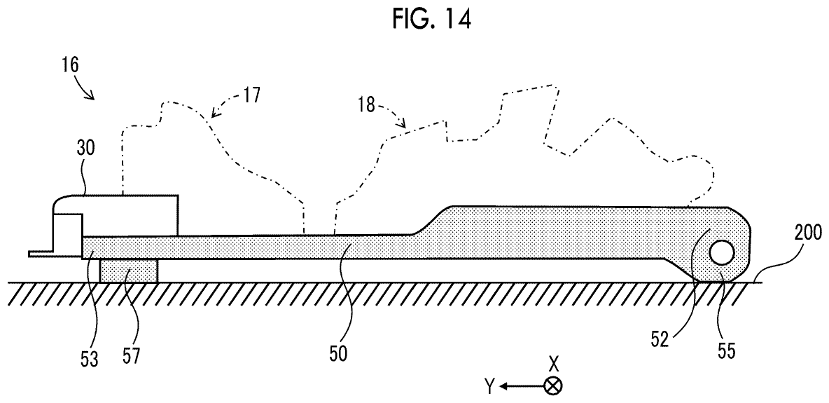

FIG. 14 is a side view showing the internal structure 16 placed on a jig 200. The internal structure 16 has unevenness on a back side or has a bulging portion 55 at the proximal end 52 of the frame 50. Therefore, in a case where the internal structure 16 is placed on the jig 200, there is a concern that the internal structure 16 is unstable and shakes. Therefore, in order to stably place the internal structure 16 on the jig 200, as shown in FIG. 14, each of the two frames 50 (only one is shown in the figure) may have one or more legs 57. The leg 57 supports the internal structure 16 so that the internal structure 16 does not shake on the jig 200. The leg 57 is housed in a space between the exterior cover 15 and the frame 50 in a stage before the separation of the exterior cover 15 and the internal structure 16. The leg 57 may be provided by attaching a member to the frame 50 or may be provided by bending the frame 50.

### Supplementary Notes

(((1)

A paper transport device comprising:
a paper transport path on which paper is transported; and
a side cover that is rotatable about a support shaft with respect to a side surface of a device main body and is capable of being disposed at a closed position and an open position,
wherein the side cover is configured to form at least a part of the paper transport path between the side cover and the device main body at the closed position and to expose at least a part of the paper transport path at the open position,
the side cover includes an exterior cover and an internal structure disposed on a device main body side of the exterior cover,
the internal structure of the side cover includes a pair of frames disposed at an interval in a lateral direction in which the support shaft of the side cover extends,
each of the pair of frames extends in a longitudinal direction intersecting the lateral direction, is fastened to the exterior cover, and includes a proximal end close to the support shaft of the side cover and a distal end far from the support shaft,
the internal structure of the side cover includes a connecting member that connects the distal ends of the pair of frames to each other and extends in the lateral direction, and
the connecting member includes an extending portion that extends outward in the longitudinal direction with respect to the distal end of each of the pair of frames.
   (((2)))

The paper transport device according to (((1))),
wherein the extending portion of the connecting member extends outward in the lateral direction with respect to the distal end of at least one of the pair of frames.
   (((3)))

The paper transport device according to (((1))) or (((2))),
wherein the connecting member includes an overlapping portion that overlaps with the distal end of the frame in each of the pair of frames,
the overlapping portion of the connecting member is fastened to the distal end of the frame, and
the extending portion of the connecting member is fastened to the exterior cover.
   (((4)))

The paper transport device according to any one of (((1))) to (((3))),
wherein the exterior cover and the internal structure are fastened by a plurality of fastening portions, and
each of all the fastening portions has a tool receiving portion facing the device main body side such that fastening is released by an operation with a tool from the device main body side.
   (((5)))

The paper transport device according to any one of (((1))) to (((4))),
wherein the extending portion of the connecting member includes a protruding portion that has a hat shape in which a cross section along the longitudinal direction has an opening on an exterior cover side, and that extends in the lateral direction.
   (((6)))

The paper transport device according to (((5))),
wherein the extending portion of the connecting member includes a cover fastening portion fastened to the exterior cover, and
the protruding portion of the extending portion protrudes toward the device main body side with respect to the cover fastening portion of the extending portion.
   (((7)))

The paper transport device according to any one of (((1)) to (6)
wherein the exterior cover includes a cover body and a handle body that is disposed to be slidable in the longitudinal direction with respect to the cover body, and
the handle body includes
   a hook portion that protrudes toward an inside of the exterior cover and is engaged with an engaging portion of the device main body, and
   a handle portion that is located on an outside of the exterior cover and slides the handle body in a direction in which the hook portion and the engaging portion are disengaged from each other.
      (((8)))

The paper transport device according to (((7))),
wherein the handle body of the exterior cover has a boss that fits into a recess portion of the cover body of the exterior cover to guide sliding of the handle body, and
the cover body of the exterior cover has another boss that fits into a recess portion of the handle body of the exterior cover to guide sliding of the handle body.
   (((9),

The paper transport device according to any one of (((1))) to (((8))),
wherein a part of the connecting member forms at least a part of the paper transport path between the part of the connecting member and the device main body at the closed position of the side cover.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. A paper transport device comprising:
a paper transport path on which paper is transported; and
a side cover that is rotatable about a support shaft with respect to a side surface of a device main body and is capable of being disposed at a closed position and an open position,
wherein the side cover is configured to form at least a part of the paper transport path between the side cover and the device main body at the closed position and to expose at least a part of the paper transport path at the open position,
the side cover includes an exterior cover and an internal structure disposed on a device main body side of the exterior cover,
the internal structure of the side cover includes a pair of frames disposed at an interval in a lateral direction in which the support shaft of the side cover extends,
each of the pair of frames extends in a longitudinal direction intersecting the lateral direction, is fastened to the exterior cover, and includes a proximal end close to the support shaft of the side cover and a distal end far from the support shaft,
the internal structure of the side cover includes a connecting member that connects the distal ends of the pair of frames to each other and extends in the lateral direction, and
the connecting member includes an extending portion that extends outward in the longitudinal direction with respect to the distal end of each of the pair of frames.

2. The paper transport device according to claim 1,
wherein the extending portion of the connecting member extends outward in the lateral direction with respect to the distal end of at least one of the pair of frames.

3. The paper transport device according to claim 1,
wherein the connecting member includes an overlapping portion that overlaps with the distal end of the frame in each of the pair of frames,
the overlapping portion of the connecting member is fastened to the distal end of the frame, and
the extending portion of the connecting member is fastened to the exterior cover.

4. The paper transport device according to claim 2,
wherein the connecting member includes an overlapping portion that overlaps with the distal end of the frame in each of the pair of frames,
the overlapping portion of the connecting member is fastened to the distal end of the frame, and
the extending portion of the connecting member is fastened to the exterior cover.

5. The paper transport device according to claim 1,
wherein the exterior cover and the internal structure are fastened by a plurality of fastening portions, and
each of all the fastening portions has a tool receiving portion facing the device main body side such that fastening is released by an operation with a tool from the device main body side.

6. The paper transport device according to claim 2,
wherein the exterior cover and the internal structure are fastened by a plurality of fastening portions, and
each of all the fastening portions has a tool receiving portion facing the device main body side such that fastening is released by an operation with a tool from the device main body side.

7. The paper transport device according to claim 1,
wherein the extending portion of the connecting member includes a protruding portion that has a hat shape in which a cross section along the longitudinal direction has an opening on an exterior cover side, and that extends in the lateral direction.

8. The paper transport device according to claim 2,
wherein the extending portion of the connecting member includes a protruding portion that has a hat shape in which a cross section along the longitudinal direction has an opening on an exterior cover side, and that extends in the lateral direction.

9. The paper transport device according to claim 7,
wherein the extending portion of the connecting member includes a cover fastening portion fastened to the exterior cover, and
the protruding portion of the extending portion protrudes toward the device main body side with respect to the cover fastening portion of the extending portion.

10. The paper transport device according to claim 8,
wherein the extending portion of the connecting member includes a cover fastening portion fastened to the exterior cover, and
the protruding portion of the extending portion protrudes toward the device main body side with respect to the cover fastening portion of the extending portion.

11. The paper transport device according to claim 1,
wherein the exterior cover includes a cover body and a handle body that is disposed to be slidable in the longitudinal direction with respect to the cover body, and
the handle body includes
a hook portion that protrudes toward an inside of the exterior cover and is engaged with an engaging portion of the device main body, and
a handle portion that is located on an outside of the exterior cover and slides the handle body in a direction in which the hook portion and the engaging portion are disengaged from each other.

12. The paper transport device according to claim 2,
wherein the exterior cover includes a cover body and a handle body that is disposed to be slidable in the longitudinal direction with respect to the cover body, and
the handle body includes
a hook portion that protrudes toward an inside of the exterior cover and is engaged with an engaging portion of the device main body, and
a handle portion that is located on an outside of the exterior cover and slides the handle body in a direction in which the hook portion and the engaging portion are disengaged from each other.

13. The paper transport device according to claim 11,
wherein the handle body of the exterior cover has a boss that fits into a recess portion of the cover body of the exterior cover to guide sliding of the handle body, and
the cover body of the exterior cover has another boss that fits into a recess portion of the handle body of the exterior cover to guide sliding of the handle body.

14. The paper transport device according to claim 12,
wherein the handle body of the exterior cover has a boss that fits into a recess portion of the cover body of the exterior cover to guide sliding of the handle body, and
the cover body of the exterior cover has another boss that fits into a recess portion of the handle body of the exterior cover to guide sliding of the handle body.

15. The paper transport device according to claim 1,
wherein a part of the connecting member forms at least a part of the paper transport path between the part of the connecting member and the device main body at the closed position of the side cover.

16. The paper transport device according to claim 2,
wherein a part of the connecting member forms at least a part of the paper transport path between the part of the connecting member and the device main body at the closed position of the side cover.
